(19) United States
(12) Patent Application Publication
(10) Pub. No.: US 2023/0116831 A1
(43) Pub. Date: Apr. 13, 2023

(54) DISPLAY DEVICE

(71) Applicant: LG ELECTRONICS INC., Seoul (KR)

(72) Inventors: Hodong HWANG, Seoul (KR); Kangyeung LEE, Seoul (KR); Sungphil HWANG, Seoul (KR)

(73) Assignee: LG ELECTRONICS INC., Seoul (KR)

(21) Appl. No.: 17/799,899

(22) PCT Filed: Mar. 31, 2020
(86) PCT No.: PCT/KR2020/004433

§ 371 Date: Aug. 15, 2022

(51) Int. Cl. G09G 3/34

(52) U.S. Cl. CPC G09G 3/3406; G09G 2320/0626; G09G 2320/0666; G09G 2360/144

(57) ABSTRACT

A display device fixed to a wall, according to one embodiment of the present disclosure, may comprise: a display; one or more illuminance sensors for acquiring illuminance information including the amount of light entering from outside; and a processor for acquiring the color of a wall, adjusting one or more image quality elements of a source image, on the basis of one or more among the illuminance information and the wall color, and displaying, on the display, the source image for which the one or more image quality elements have been adjusted.

### TECHNICAL FIELD

The present disclosure relates to a display device, and more particularly, to a wall display device.

### BACKGROUND ART

A wall display is a type of display of which a rear surface is fixed to a wall, the wall display being exhibited.

The wall display may be used as a picture frame by displaying a picture or a painting when operating in a standby mode in a house. That is, the wall display may be used harmoniously with the interior decoration of a house.

The wall display is mainly used to reproduce moving images or still images.

In a conventional wall display, the image quality factor (brightness, saturation, or the like) of a screen is adjusted to the same value for the entire area of the screen, and the position of a light source is not considered, which may cause a sense of heterogeneity in viewing.

That is, the conventional wall display does not consider light introduced from the outside, and the brightness of one part of an image is different from the brightness of the other part according to the light, so that the user feels uncomfortable in viewing the image.

### DISCLOSURE

### Technical Problem

An object of the present disclosure is to provide a display device capable of adjusting an image quality factor in consideration of light introduced from the outside.

An object of the present disclosure is to provide a display device capable of adjusting an image quality factor based on light introduced from the outside and a color of a wall positioned at the rear side of the display device.

### Technical Solution

According to an embodiment of the present disclosure, a display device fixed to a wall may comprise: a display; illuminance sensors configured to obtain illuminance information including an amount of light introduced from outside; and a processor configured to obtain a color of the wall, adjust one or more image quality factors of a source image, based on one or more of the illuminance information and the color of the wall, and display, on the display, the source image of which the one or more image quality factors have been adjusted.

The processor may separate the source image into a main image containing image information and an auxiliary image containing no image information, adjust an output brightness of the main image based on the illuminance information, and adjust a color and an output brightness of the auxiliary image based on the illuminance information and the color of the wall.

The display device may further include a memory configured to store a table indicating a correspondence relationship between the amount of light and the output brightness.

The processor may divide the main area in which the main image is displayed into a plurality of areas, extract an output brightness matching an amount of light detected in each area through the table, and adjust a brightness of each area to the extracted output brightness.

The processor may decrease the output brightness as the amount of light increases and increase the output brightness as the amount of light decreases.

The color of the wall may set according to a user input or obtained through analysis of an image taken through a user’s mobile terminal.

The processor may adjust a color of the auxiliary image to a color identical to the color of the wall.

The auxiliary image may be a letter box inserted to adjust a display ratio of the source image.

The display device may further include a memory configured to store a sun position inference model for inferring a sun position, supervised by a machine learning algorithm or a deep learning algorithm, and the processor may determine the sun position using the sun position inference model based on the illuminance information, location information of the display device, and time information.

The processor may adjust an output brightness of the source image with a brightness corresponding to the determined sun position.

### Advantageous Effects

According to various embodiments of the present disclosure, an image quality factor of each area of an image is adjusted according to the amount of light introduced, thus enabling the user to view the image of uniform image quality.

In addition, the image quality factors of separated areas are adjusted differently by separating an area containing image information and an area including no image information, thus achieving harmonization of the interior decoration and natural image viewing.

### DESCRIPTION OF DRAWINGS

FIG. 1 is a diagram for describing a practical configuration of a display device according to an embodiment of the present disclosure.

FIG. 2 is a block diagram illustrating a configuration of a display device according to an embodiment of the present disclosure.

FIG. 3 is a diagram for describing a method of operating a display device according to an embodiment of the present disclosure.

FIG. 4 is a flowchart for describing a method of correcting an image based on an amount of light and a color of a wall according to an embodiment of the present disclosure;

FIGS. 5 and 6 are diagrams for describing an example of correcting a source image based on one or more of an amount of light and a color of a wall according to an embodiment of the present disclosure.

FIG. 7 is a diagram for describing a table for storing an output brightness of a display corresponding to an amount of light detected by an illuminance sensor.

FIG. 8 is a diagram for describing a process of adjusting an image quality factor of a source image according to an embodiment of the present disclosure.

FIG. 9 is a diagram for describing a process of adjusting an image quality factor of a source image according to another embodiment of the present disclosure.

FIG. 10 is a diagram for describing a learning process of a sun position inference model according to an embodiment of the present disclosure.

### BEST MODE

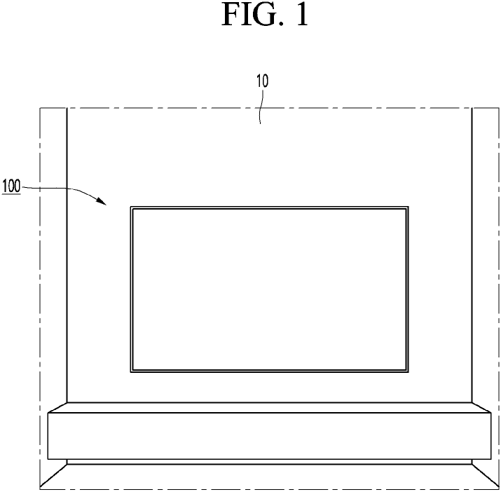

FIG. 1 is a diagram for describing a practical configuration of a display device according to an embodiment of the present disclosure.

A display device 100 may be implemented with a TV, a tablet PC, a digital signage, or the like.

The display device 100 of FIG. 1 may be fixed to a wall 10. As the display device 100 is fixed to the wall, the display device 100 may be referred to as a wall display device.

The wall display device 100 may be provided in a house and perform a decorative function. The wall display device 100 may display a picture or a painting, and may be used as a single frame.

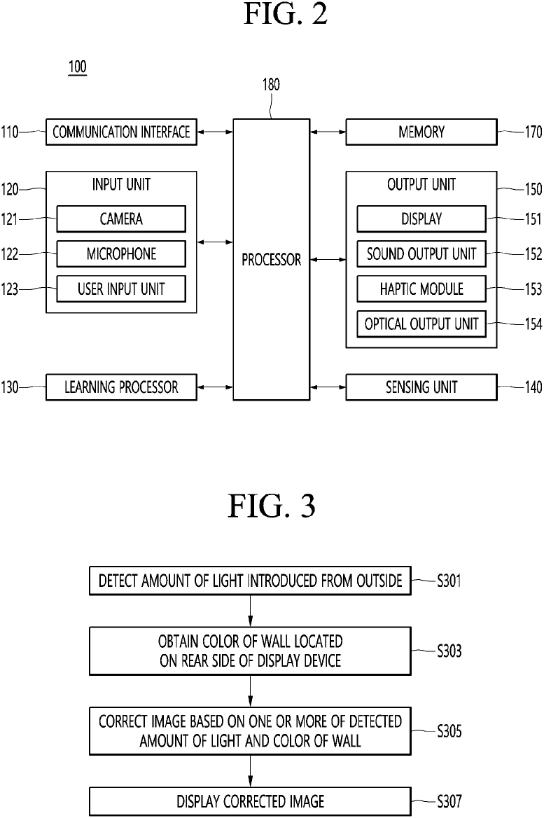

FIG. 2 is a block diagram for describing components of a display device according to an embodiment of the present disclosure.

In particular, the components of FIG. 2 may be provided in the head 101 of FIG. 1.

Referring to FIG. 2, the display device 100 may include a communication unit 110, an input unit 120, a learning processor 130, a sensing unit 140, an output unit 150, a memory 170, and a processor 180.

The communication unit 110 may transmit/receive data to and from external devices such as other terminals or external servers using wired/wireless communication technologies. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The input unit 120 may include a camera 121 for inputting an image signal, a microphone 122 for receiving an audio signal, and a user input unit 123 for receiving information from a user.

The speech data or image data collected by the input unit 120 may be analyzed and processed as a control command of the user.

The input unit 120 is for inputting image information (or signal), audio information (or signal), data, or information input from a user. In order to input image information, the display device 100 may include one or a plurality of cameras 121.

The camera 121 processes image frames such as still images or moving images obtained by an image sensor in a video call mode or a photographing mode. The processed image frames may be displayed on the display unit 151 or stored in the memory 170.

The microphone 122 processes external sound signals as electrical speech data. The processed speech data may be utilized in various ways according to a function (or running application program) being performed in the display device 100. Meanwhile, various noise reduction algorithms may be applied in the microphone 122 to remove noise occurring in the process of receiving an external sound signal.

The user input unit 123 is for receiving information from a user. When information is input through the user input unit 123, the processor 180 may control the operation of the display device 100 to correspond to the input information when the information is inputted through the user input unit 123.

The user input unit 123 may include mechanical input means (or a mechanical key, for example, a button, a dome switch, a jog wheel, or a jog switch located at the front/rear or side of the display device 100) and touch input means. As an example, the touch input means may include a virtual key, a soft key, or a visual key displayed on the touch screen through software processing, or a touch key disposed in the other portion than the touch screen.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may include a memory integrated or implemented in the display device 100. Alternatively, the learning processor 130 may be implemented by using the memory 170, an external memory directly connected to the display device 100, or a memory held in an external device.

The sensing unit 140 may acquire at least one of internal information about the display device 100, ambient environment information about the display device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The output unit 150 may include at least one of a display unit 151, a sound output unit 152, a haptic module 153, and an optical output unit 154.

The display unit 151 displays (outputs) information processed by the display device 100. For example, the display unit 151 may display execution screen information of an application program running on the display device 100, or UI (User Interface) or Graphic User Interface (GUI) information according to the execution screen information.

The display unit 151 may implement a touch screen in such a manner that the display unit 151 forms a layer structure with or is integrally formed with a touch sensor. Such a touch screen may function as a user input unit 123 that provides an input interface between the display device 100 and the user and may provide an output interface between the terminal 100 and the user at the same time.

The sound output unit 152 may output audio data received from the communication unit 110 or stored in the memory 170 in call signal reception, a call mode or a recording mode, a speech recognition mode, a broadcast reception mode, or the like.

The sound output unit 152 may include at least one of a receiver, a speaker, and a buzzer.

The haptic module 153 generates various tactile effects that a user is able to feel. A representative example of the tactile effect generated by the haptic module 153 may be vibration.

The optical output unit 154 outputs a signal for notifying occurrence of an event by using light of a light source of the display device 100. Examples of events generated by the display device 100 may include message reception, call signal reception, a missed call, an alarm, schedule notification, email reception, and information reception through an application, and the like.

The memory 170 may store data that supports various functions of the display device 100. For example, the memory 170 may store input data acquired by the input unit 120, learning data, a learning model, a learning history, and the like.

The processor 180 may determine at least one executable operation of the display device 100 based on information determined or generated by using a data analysis algorithm or a machine learning algorithm. The processor 180 may control the components of the display device 100 to execute the determined operation.

To this end, the processor 180 may request, search, receive, or utilize data of the learning processor 130 or the memory 170. The processor 180 may control the components of the display device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user’s requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by external server, or may be learned by their distributed processing.

The processor 180 may collect history information including the operation contents of the display device 100 or the user’s feedback on the operation and may store the collected history information in the memory 170 or the learning processor 130 or transmit the collected history information to the external device such as the external server. The collected history information may be used to update the learning model.

The processor 180 may control at least part of the components of the display device 100 so as to drive an application program stored in the memory 170. Furthermore, the processor 180 may operate two or more of the components included in the display device 100 in combination so as to drive the application program.

FIG. 3 is a diagram for describing a method of operating a display device according to an embodiment of the present disclosure.

The processor 180 of the display device 100 may detect the amount of light introduced from the outside through one or more illuminance sensors (S301).

One or more illuminance sensors may be provided in the display device 100. Each illuminance sensor may detect the amount of light that is introduced from the outside.

The illuminance sensor may transmit the detected amount of light to the processor 180.

The resistor included in the illuminance sensor may have a value varying depending on the amount of light. That is, when the amount of light increases, the resistance value of the illuminance sensor may increase, and when the amount of light decreases, the resistance value of the illuminance sensor may decrease.

The illuminance sensor may detect an amount of light corresponding to a measured current or voltage according to the changed resistance value.

The processor 180 of the display device 100 may acquire a color of a wall positioned at the rear side of the display device 100 (S303).

The rear surface of the display device 100 may be fixed to the wall 10.

In an embodiment, the color of the wall may be set through a user input. That is, the processor 180 may receive the color of the wall through a user input by using a menu displayed on the display 151.

In another embodiment, the color of the wall may be acquired based on an image captured through the user’s mobile terminal. The user may photograph a wall surface associated with the display device 100.

The mobile terminal may extract a color of the wall by analyzing the captured image, and transmit the extracted color of the wall to the display device 100.

The mobile terminal may transmit the photographed image to the display device 100, and the display device 100 may extract the color of the wall through analysis of the received image.

In still another embodiment, the processor 180 may extract the color of the wall using a camera 121 mounted on the display device 100. The camera 121 of the display device 100 may photograph the wall 10 positioned on the rear side of the display device 100, and acquire the color of the wall through analysis of the photographed image.

The processor 180 of the display device 100 may correct an image to be displayed on the display 151 based on the detected amount of light and the color of the wall (S305).

The processor 180 may divide an input image into a main image and an auxiliary image.

The processor 180 may correct the auxiliary image so that the auxiliary image has the color of the wall.

The processor 180 may adjust one or more of the brightness of the main image and the brightness of the auxiliary image having the color of the wall according to the detected amount of light.

The processor 180 of the display device 100 may display the corrected image on the display 151 (S307).

Hereinafter, the embodiment of FIG. 3 will be described in more detail.

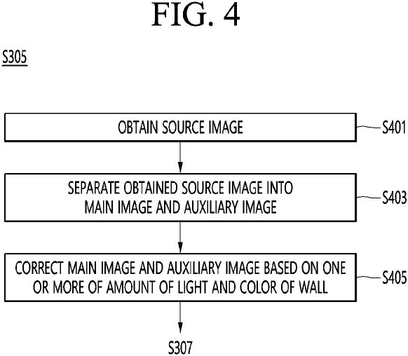

FIG. 4 is a flowchart for describing a method of correcting an image based on an amount of light and a color of a wall according to an embodiment of the present disclosure;

In particular, FIG. 4 is a detailed embodiment of step S305 of FIG. 3.

Referring to FIG. 4, the processor 180 of the display device 100 may acquire a source image (S401).

In an embodiment, the source image may be either a moving image or a still image.

The still image may be an image displayed on a standby screen of the display device 100.

The processor 180 of the display device 100 may divide the acquired source image into a main image and an auxiliary image (S403).

The main image may be an image including an object, and the auxiliary image may be an image including no object. The auxiliary image may be a letter box (black image) used to match a display ratio of a content image.

The auxiliary image may be inserted as a part of a movie content image or a part of a screen mirrored image.

The processor 180 may extract the main image and the auxiliary image from the source image based on an identifier for identifying the auxiliary image.

The processor 180 of the display device 100 may correct each of the main image and the auxiliary image based on at least one of the amount of light and the color of the wall (S405).

[100] The processor 180 may adjust the brightness of the main image based on the amount of light detected through one or more illuminance sensors.

For example, the processor 180 may adjust the brightness of each of a plurality of main areas occupied by the main image based on the detected amount of light.

The processor 180 may correct the main image such that the entire area of the main image is output with uniform brightness.

The processor 180 may adjust the color of the auxiliary image based on the color of the wall. The processor 180 may correct the output color of the auxiliary image such that the color of the auxiliary image is identical to the color of the wall.

When the auxiliary image has a black color, the processor 180 may perform correction from the black color to the color of the wall.

Additionally, the processor 180 may adjust the brightness of the color of the auxiliary image based on the amount of light. For example, the processor 180 may decrease the brightness of the color of an area in which a large amount of light is detected and increase the brightness of the color of an area in which a small amount of light is detected.

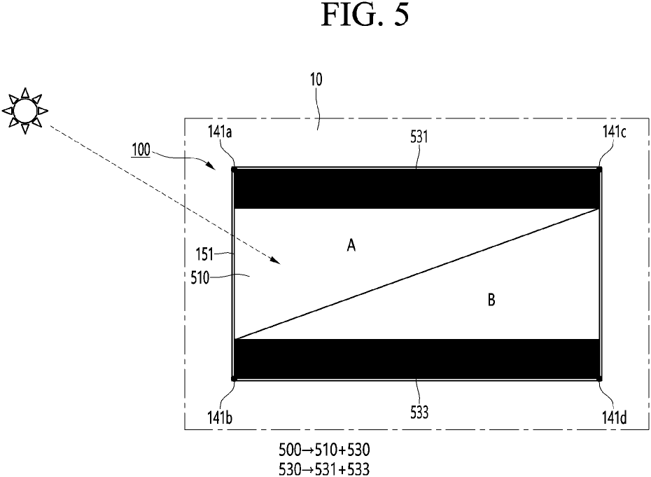

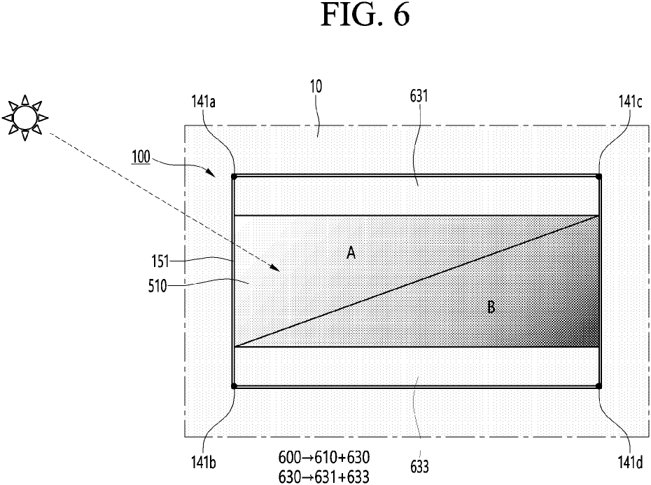

FIGS. 5 and 6 are diagrams for describing an example of correcting a source image based on one or more of an amount of light and a color of a wall according to an embodiment of the present disclosure.

Referring to FIGS. 5 and 6, the display device 100 may include four illuminance sensors 141a to 141d outside a cover surrounding the display 151.

In FIGS. 5 and 6, it is assumed that there are four illuminance sensors, but this is only an example, and more or fewer illuminance sensors may be provided.

FIG. 5 shows a source image 500 before correction, and FIG. 6 shows an output image 600 after the source image is corrected.

The source image 500 before correction may include a main image 510 and an auxiliary image 530.

The auxiliary image 530 is an image for matching the display ratio of the main image 510 and may be a black image. The auxiliary image 530 may include a first letter box 531 located above the main image 510 and a second letter box 533 located below the main image 510.

Each of the plurality of illuminance sensors 141a to 141d may detect an amount of light.

The processor 180 may measure the amount of light measured in each of a first main area (A) and a second main area (B) of the main image 510.

In FIG. 5, the entire area in which the main image 510 is displayed is divided into two areas, but this is only an example.

When the amount of light in the first main area (A) is greater than a reference amount, the processor 180 may decrease the brightness of the first main area A to a preset value.

When the amount of light in the second main area (B) is less than the reference amount, the processor 180 may increase the brightness of the second main area (B) to a preset value.

Referring to FIG. 6, a main image 600 after correction is shown. That is, the main image 600 after correction may be an image whose brightness is adjusted according to the amount of detected light.

A user can view an image that is not affected by light through the the main image 600 after correction. That is, the user may not feel a sense of heterogeneity that may be caused by a difference in brightness between a part of the image and that of the rest of the image, due to light.

Meanwhile, the processor 180 may obtain the color of the wall 10 and adjust the color of the auxiliary image 530 to match the color of the wall 10.

When the color of the wall 10 is gray, the processor 180 may correct the colors of each of the first letter box 531 and the second letter box 533 of the auxiliary image 530 to have gray.

Referring to FIG. 6, it is shown that the color of the corrected auxiliary image 630 is the same as the color of the wall 10.

Accordingly, the user is not disturbed in viewing the image with the existing unnecessary auxiliary image.

That is, the user can more naturally focus on viewing the main image.

Meanwhile, the processor 180 may adjust the brightness of the color of the corrected auxiliary image 630 by additionally considering the amount of detected light.

For example, when the amount of light detected in the area occupied by a first output auxiliary image 631 of the auxiliary image 630 is equal to or greater than the reference amount, the processor 180 may decrease the brightness of the color of the first output auxiliary image 631.

When the amount of light detected in the area occupied by a second output auxiliary image 633 of the auxiliary image 630 is less than the reference amount, the processor 180 may increase the brightness of the color of the first output auxiliary image 631.

According to the amount of light introduced from the outside, the brightness of the output auxiliary image 630 is also appropriately adjusted, achieving harmony with the wall 10 more naturally.

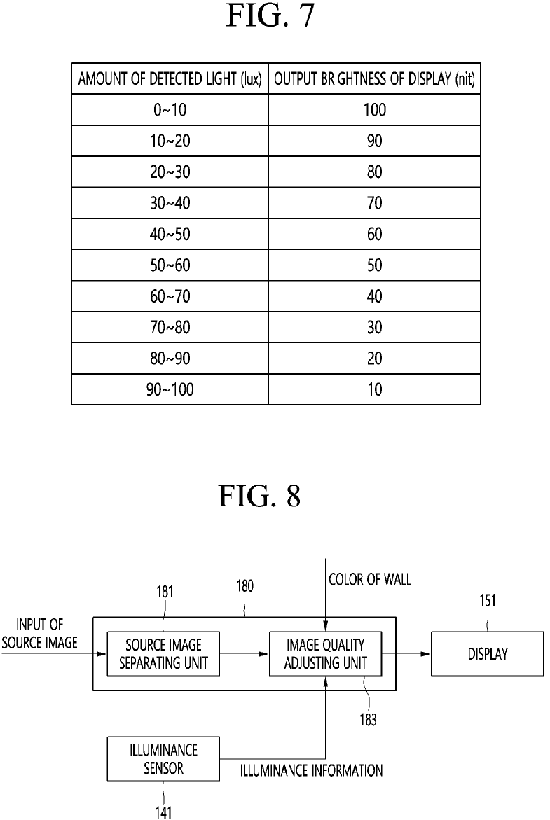

FIG. 7 is a diagram for describing a table for storing an output brightness of a display corresponding to an amount of light detected by an illuminance sensor.

Referring to FIG. 7, a table for describing the output brightness of the display 151 corresponding to the amount of light detected by the illuminance sensor is shown.

The table of FIG. 7 may be stored in the memory 170 of the display device 100.

The processor 180 may detect the amount of light in each area among a plurality of areas included in a display area of the display 151.

The processor 180 may extract an output brightness matching the amount of detected light from the table stored in the memory 170.

The processor 180 may control a corresponding area to output the extracted output brightness. For example, the processor 180 may control a backlight unit that provides light to a corresponding area.

The amount of light and the output brightness shown in FIG. 7 are exemplary values.

The processor 180 may divide the main area in which the main image is displayed into a plurality of areas, extract an output brightness matching the amount of light detected in each area through the table, and adjust a brightness of each area to the extracted output brightness.

FIG. 8 is a diagram for describing a process of adjusting an image quality factor of a source image according to an embodiment of the present disclosure.

Referring to FIG. 8, the processor 180 may include a source image separating unit 181 and an image quality factor adjusting unit 183.

The source image separating unit 181 may separate a source image input from the outside into a main image and an auxiliary image. The source image may be input through a tuner, an external input interface, or a communication interface.

The main image may be an image containing image information, and the auxiliary image may be an image containing no image information.

The source image separating unit 181 may output the main image and the auxiliary image which have separated to the image quality factor adjusting unit 183.

The image quality factor adjusting unit 183 may adjust the image quality factors of the main image and the auxiliary image based on the illuminance information transferred from the illuminance sensor 140.

The illuminance information may include the amount of light detected by each of the plurality of illuminance sensors.

The image quality factor may include one or more of a color of an image and an output brightness of an image.

The quality factor adjusting unit 183 may divide a main area in which the main image is displayed into a plurality of areas, determine an output brightness appropriate for the amount of light detected in each area, and output the main image with the determined output brightness.

The image quality factor adjusting unit 183 may adjust the color of the auxiliary image to have the same color as the color of the wall 10.

The image quality factor adjusting unit 183 may adjust the output brightness of the auxiliary image by detecting the amount of light detected in an area where the auxiliary image having the adjusted color is displayed.

The image quality factor adjusting unit 183 may output a corrected image obtained by adjusting the image quality factor of the main image and the image quality factor of the auxiliary image to the display 151.

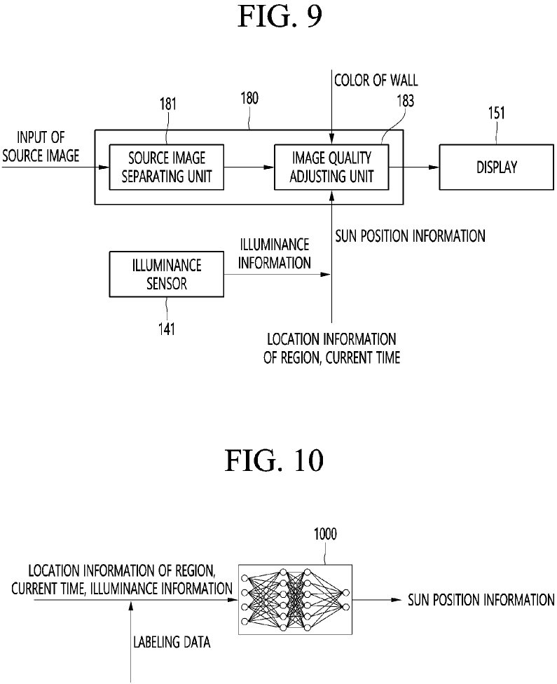

FIG. 9 is a diagram for describing a process of adjusting an image quality factor of a source image according to another embodiment of the present disclosure.

FIG. 9 is a diagram for describing a process of adjusting an image quality factor of a source image by additionally considering sun position information, compared to FIG. 8.

The image quality factor adjusting unit 183 may adjust the image quality factor of a main image and the image quality factor of an auxiliary image based on illuminance information, the color of the wall 10, and sun position information.

The sun position information may be obtained based on location information of a region in which the display device 100 is located, a current time, and sunrise/sunset time information.

The processor 180 itself may estimate the sun position information, or may receive the sun position information from an external server.

The image quality factor adjusting unit 183 may adjust the output brightness of the main image and the auxiliary image based on the illuminance information and the sun position information.

The image quality factor adjusting unit 183 may adjust the output brightness of the main image and the auxiliary image by additionally considering the sun position information in addition to the amount of light included in the illuminance information.

The image quality factor adjusting unit 183 may decrease the output brightness of the main image and the auxiliary image when the sun is in a position that has more influence on the viewing of the image, and increase the output brightness of the main image and the auxiliary image when the sun is in a position that has less influence on the viewing of the image.

The image quality factor adjusting unit 183 may obtain the sun position information by using a sun position inference model trained by a deep learning algorithm or a machine learning algorithm.

The image quality factor adjusting unit 183 may infer the sun position information using the sun position inference model based on illuminance information, the location information of the region where the display device 100 is located, and time information.

The image quality factor adjusting unit 183 may determine the output brightness of the display 151 based on the sun position information.

The output brightness of the display 151 may be predetermined according to the sun position. A table defining a correspondence relationship between the sun positions and the output brightness of the display 151 may be stored in the memory 170.

FIG. 10 is a diagram for describing a learning process of a sun position inference model according to an embodiment of the present disclosure.

Referring to FIG. 10, the sun position inference model 1000 may be an artificial neural network-based model supervised by a deep learning algorithm or a machine learning algorithm.

The sun position inference model 1000 may be a model trained by the learning processor 130 or a model trained by and received from an external server.

The sun position inference model 1000 may be an individually trained model for each display device 100.

The sun position inference model 1000 may be a model composed of an artificial neural network trained to infer a sun position representing a feature point (or an output feature point) by using training data of the same format as the viewing circumstance data as input data.

The sun position inference model 1000 may be trained through supervised learning. Specifically, the sun position may be labeled in training data used for training the sun position inference model 1000, and the sun position inference model 1000 may be trained using the labeled training data.

The viewing circumstance data for training may include location information of a region in which the display device 100 is located, time information, and illuminance information.

The loss function (cost function) of the sun position inference model may be expressed as a square mean of a difference between a label for a sun position corresponding to each training data and a sun position inferred from each training data.

In addition, the sun position inference model 1000 may determine model parameters included in the artificial neural network to minimize the cost function through training.

That is, the sun position inference model 1000 may be an artificial neural network model on which supervised learning has been performed using the viewing circumstance data for training and its corresponding labeled sun position information.

When an input feature vector is extracted from the viewing circumstance data for training and inputted, a result of determining a sun position is output as a target feature vector, and the sun position inference model 1000 may be trained to minimize a loss function corresponding to the difference between the target feature vector which is output and the labeled sun position.

According to an embodiment of the present disclosure, the above-described method may be implemented with codes readable by a processor on a medium in which a program is recorded. Examples of the medium readable by the processor include a ROM (Read Only Memory), a Random Access Memory (RAM), a CD-ROM, a magnetic tape, a floppy disk, an optical data storage device, and the like.

The display device as described above is not limited to the configuration and method of the above-described embodiments, but the embodiments may be configured by selectively combining all or part of each embodiment such that various modifications can be made.

1. A display device fixed to a wall,
a display;
illuminance sensors configured to obtain illuminance information including an amount of light introduced from outside; and
a processor configured to obtain a color of the wall, adjust one or more image quality factors of a source image, based on one or more of the illuminance information and the color of the wall, and display, on the display, the source image of which the one or more image quality factors have been adjusted.

2. The display device of claim 1, wherein the processor is configured to:
separate the source image into a main image containing image information and an auxiliary image containing no image information,
adjust an output brightness of the main image based on the illuminance information, and
adjust a color and an output brightness of the auxiliary image based on the illuminance information and the color of the wall.

3. The display device of claim 2, further comprising:
a memory configured to store a table indicating a correspondence relationship between the amount of light and the output brightness.

4. The display device of claim 3, wherein the processor is configured to divide the main area in which the main image is displayed into a plurality of areas, extract an output brightness matching an amount of light detected in each area through the table, and adjust a brightness of each area to the extracted output brightness.

5. The display device of claim 4, wherein the processor is configured to decrease the output brightness as the amount of light increases and increase the output brightness as the amount of light decreases.

6. The display device of claim 1, wherein the color of the wall is set according to a user input or obtained through analysis of an image taken through a user’s mobile terminal.

7. The display device of claim 2, wherein the processor is configured to adjust a color of the auxiliary image to a color identical to the color of the wall.

8. The display device of claim 2, wherein the auxiliary image is a letter box inserted to adjust a display ratio of the source image.

9. The display device of claim 1, further comprising:
a memory configured to store a sun position inference model for inferring a sun position, supervised by a machine learning algorithm or a deep learning algorithm,
wherein the processor is configured to determine the sun position using the sun position inference model based on the illuminance information, location information of the display device, and time information.

10. The display device of claim 9, wherein the processor is configured to adjust an output brightness of the source image with a brightness corresponding to the determined sun position.
